(19) United States
(12) Patent Application Publication
(10) Pub. No.: US 2026/0257656 A1
(43) Pub. Date: Sep. 3, 2026

(54) PRIMARY PISTON FOR A MAIN BRAKE CYLINDER OR A TRANSMISSION DEVICE

(71) Applicant: Robert Bosch GmbH, Stuttgart (DE)

(72) Inventors: Willi Nagel, Remseck/Hochdorf (DE); Herbert Vollert, Vaihingen/Enz (DE); Michael Osses, Flein (DE)

(21) Appl. No.: 18/864,953

(22) PCT Filed: May 22, 2023
(86) PCT No.: PCT/EP2023/063604

§ 371 Date: Nov. 12, 2024

(30) Foreign Application Priority Data
May 30, 2022 (DE) 10 2022 205 422.9

(51) Int. Cl. B60T 13/74

(52) U.S. Cl. CPC B60T 13/745

(57) ABSTRACT

A primary piston for a main brake cylinder or a transmission device. The primary piston has, on a first side, a first recess into which at least one portion, directed toward the primary piston, of a primary spring of a main brake cylinder is able to be introduced or is fastened. On a second side, directed away from the first side, of the primary piston a second recess is formed, into which at least one portion, directed toward the primary piston, of a spindle of a transmission device and, at the same time, at least one portion, directed toward the primary piston, of a nut, arranged on the spindle, of the transmission device are able to be introduced and/or are fastened, The first recess, formed on the first side of the primary piston, frames at least one portion, directed toward the first side, of the second recess.

### FIELD

The present invention relates to a primary piston for a main brake cylinder or a transmission device. The present invention also relates to a main brake cylinder for a brake-by-wire braking system, a transmission device for a brake-by-wire braking system, and a brake pressure generator for a brake-by-wire braking system.

### BACKGROUND INFORMATION

In the related art, such as German Patent Application No. DE 10 2017 203 559 A1 for example, a primary piston for a main brake cylinder is described, which can interact with an electromechanical brake booster arranged upstream of the main brake cylinder. On its first side, the primary piston is supported by a primary spring projecting into a recess in the primary piston, while a force is intended to be transferable to a second side of the primary piston directed away from the first side by means of a spindle and nut of the electromechanical brake booster.

### SUMMARY

The present invention provides a primary piston for a main brake cylinder or a transmission device, a main brake cylinder for a brake-by-wire braking system, a transmission device for a brake-by-wire braking system, and a brake pressure generator for a brake-by-wire braking system.

The present invention provides a primary piston whose advantageous shape enables a shortening of the overall length of a brake pressure generator equipped with the primary piston and combining the functions of a main brake cylinder and a transmission device. Since at least the portion of the spindle of the brake pressure generator that is directed toward the primary piston and at the same time at least the portion of the nut of the brake pressure generator that is directed toward the brake piston can be and/or are introduced into the second recess of the primary piston, the compactness of the brake pressure generator equipped with the primary piston according to the present invention is also increased. By the reduction in the overall length of the brake pressure generator, or the increased compactness of its design, achieved by means of the present invention, installation space can be saved on a vehicle/motor vehicle constructed therewith.

In an advantageous embodiment of the primary piston of the present invention, at least the portion of the spindle that is directed toward the primary piston can be or is fastened in the second recess, while at the same time at least the portion of the nut set in a rotational movement about the spindle that is directed toward the primary piston can be introduced into the second recess. This means that an installation space created in the primary piston can be used for the cooperating spindle and nut.

In a further advantageous embodiment of the primary piston of the present invention, at least the portion of the nut that is directed toward the primary piston can be or is fastened in the second recess, while at the same time at least the portion of the spindle set in a rotational movement that is directed toward the primary piston can be introduced into the second recess. As will become clear from the following description, in the embodiment of the primary piston described here, the nut cooperating therewith can be (almost) completely “sunk” into the second recess, which results in a significant reduction in the overall length of the brake pressure generator equipped therewith.

If at least the portion of the nut that is directed toward the primary piston is fastened in the second recess, the nut can be a ball nut or a threaded nut. Thus, advantageous types of nuts can be used to cooperate with the primary piston according to the present invention.

The advantages described above are also ensured in a main brake cylinder for a brake-by-wire braking system having such a primary piston and the primary spring cooperating with the primary piston, at least the portion of the primary spring that is directed toward the primary piston being fastened in the first recess of the primary piston.

According to an example embodiment of the present invention, preferably, a housing of the main brake cylinder is a chill casting. In this case, the housing of the main brake cylinder can be manufactured comparatively inexpensively.

The advantages described above are also realized in a transmission device for a brake-by-wire braking system having a corresponding primary piston, the spindle, and the nut arranged on the spindle, which cooperate with the primary piston, at least the portion of the spindle that is directed toward the primary piston or at least the portion of the nut that is directed toward the primary piston being fastened in the second recess of the primary piston.

As an advantageous development of the present invention, if at least the portion of the spindle that is directed toward the primary piston is fastened in the second recess of the primary piston, at least one torque support component can be fastened or formed on the primary piston, by means of which the primary piston is supported on an inner wall of a transmission housing of the transmission device. Alternatively, if at least the portion of the nut that is directed toward the primary piston is fastened in the second recess of the primary piston, at least one torque support component can be fastened or formed on the nut, by means of which the nut is supported on the inner wall of the transmission housing of the transmission device. In both cases, an undesirable co-rotational movement of the primary piston can be prevented by means of the at least one torque support component.

Furthermore, according to an example embodiment of the present invention, a brake pressure generator for a brake-by-wire braking system also has the advantages explained above, which brake pressure generator is equipped with such a primary piston, the main brake cylinder cooperating with the primary piston, and its primary spring, at least the portion of the primary spring that is directed toward the primary piston being fastened in the first recess of the primary piston, and the transmission device cooperating with the primary piston with its spindle and its nut arranged on the spindle, at least the portion of the spindle that is directed toward the primary piston or at least the portion of the nut that is directed toward the primary piston being fastened in the second recess of the primary piston.

In an advantageous embodiment of the brake pressure generator of the present invention, a housing of the main brake cylinder is a chill casting. In this case, the housing of the main brake cylinder can be manufactured cost-effectively.

Alternatively or additionally, the housing of the main brake cylinder can be screwed to the transmission housing of the transmission device. This makes it easier to repair or replace the main brake cylinder.

### BRIEF DESCRIPTION OF THE DRAWINGS

Further features and advantages of the present invention will be explained in the following with reference to the figures.

FIG. 1 is a schematic representation of a first embodiment of the primary piston, or the brake pressure generator equipped therewith, according to the present invention.

FIG. 2 is a schematic representation of a second embodiment of the primary piston, or the brake pressure generator equipped therewith, according to an example embodiment of the present invention.

### DETAILED DESCRIPTION OF EXAMPLE EMBODIMENTS

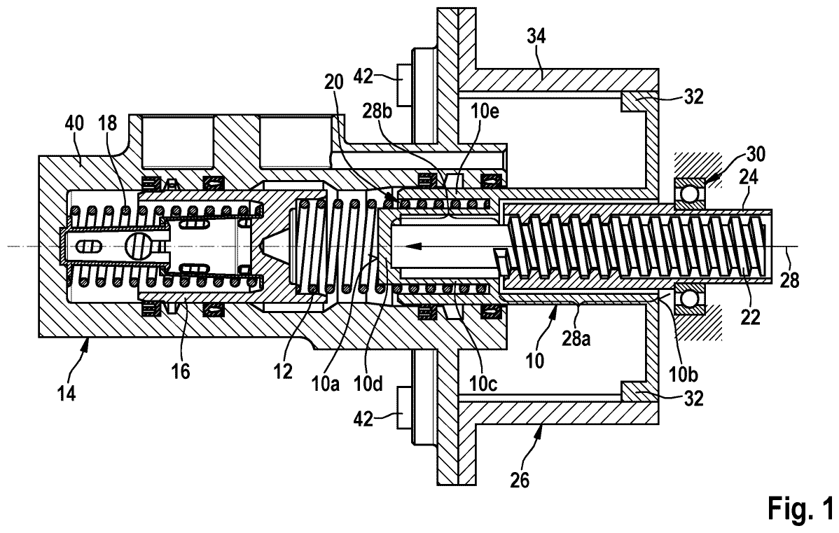

FIG. 1 is a schematic representation of a first embodiment of the primary piston, or the brake pressure generator equipped therewith.

The primary piston 10 shown schematically in FIG. 1 is shaped on a first side 10a such that a primary spring 12 of a main brake cylinder 14 equipped with or cooperating with the primary piston 10 can/does mechanically contact the primary piston 10 on the first side 10a. By way of example, in the embodiment of FIG. 1, the primary piston 10 can be supported/is supported by a secondary piston 16 of the main brake cylinder 14 by means of the primary spring 12, the secondary piston 16 being able to be supported/being supported by an inner wall of the main brake cylinder 14 by means of a secondary spring 18. Alternatively, the primary piston 10 can, however, also be supported by an inner wall of the main brake cylinder 14 by means of the primary spring 12. On the first side 10a of the primary piston 10, a first recess 20 is formed, in which at least one portion of the primary spring 12 that is directed toward the primary piston 10 can be introduced/fastened. The first side 10a of the primary piston 10 can thus be referred to as a stepped side or stepped inner contour side. The first recess 20 on the first side 10a of the primary piston 10 is preferably annular. An inner diameter of the annular first recess 20 can be less than or equal to an inner diameter of the primary spring 12, while an outer diameter of the annular first recess 20 is preferably greater than or equal to an outer diameter of the primary spring.

The primary piston 10 is also shaped on a second side 10b directed away from the first side 10a in such a way that a force can be/is transmitted to the primary piston 10 via a spindle 22 and a nut 24, arranged on the spindle 22, of a transmission device 26 equipped with or cooperating with the primary piston 10. The force can, for example, be transmitted from a motor (not shown) to the spindle 22 and the cooperating nut 24 and then transmitted further to the primary piston 10 via the spindle 22 and the nut 24. The motor can be a motor of the transmission device 26 or a motor connected externally to the transmission device 26. The spindle 22 and the nut 24 together form a rotation and translation transmission stage of the transmission device 26. The rotation and translation transmission stage formed by the spindle 22 and the nut 24 can in particular be the last transmission stage of a power transmission chain of the transmission device 26. The transmission device 26 can be at least part of an electromechanical brake booster.

As illustrated in FIG. 1, a second recess 28 is formed on the second side 10b of the primary piston 10, in which at least one portion of the spindle 22 that is directed toward the primary piston 10 and at the same time at least one portion of the nut 24 that is directed toward the primary piston 10 can be introduced and/or fastened. The second side 10b of the primary piston 10 can therefore also be described as a stepped side or stepped inner contour side of the primary piston 10. The second recess 28 is designed to be so large that the first recess 20 formed on the first side 10a of the primary piston 10 frames at least a portion of the second recess 28 directed toward the first side 10a. This can also be described as the second recess 28 of the primary piston 10 extending from the second side 10b into a piston partial volume 10c of the primary piston 10 surrounded by the first recess 20. By means of a cover portion/piston bottom 10d of the piston partial volume 10c formed on the first side 10a of the primary piston 10, penetration of brake fluid from the main brake cylinder 14 into the second recess 28 of the primary piston 10 can be prevented. Preferably, the second recess 28 of the primary piston 10 extends from its second side 10b so far into the primary piston 10 that the portion of the second recess 28 that is directed toward the first side 10a of the primary piston 10 is separated from the first side 10a of the primary piston 10 only by means of the cover portion 10d. A thickness of the cover portion 10d along a maximum extension of the primary piston 10 can, for example, be less than or equal to one tenth of the maximum extension of the primary piston 10, in particular less than or equal to one fifteenth of the maximum extension of the primary piston 10.

Due to the possibility of immersing at least the portion of the spindle 22 that is directed toward the primary piston 10 and at least the portion of the nut 24 that is directed toward the primary piston 10, created by the shape of the primary piston 10, an installation space of the primary piston 10 can be used for at least the portions of the spindle 22 and nut 24. As can be seen in FIG. 1, the above-described advantageous shape of the primary piston 10 can therefore significantly reduce the installation space length of the brake pressure generator having the functions of the brake booster 14 and the transmission device 26.

Optionally, an edge region 10e can be formed on the first side 10a of the primary piston 10, which frames the first recess 20 of the primary piston 10. The second recess 28 on the second side 10b of the primary piston 10 can comprise an outer portion 28a adjacent to the second side 10b and an inner portion 28b located on a side of the outer portion 28a that is directed away from the second side 10b. The inner portion 28b of the second recess 28 can extend into the piston partial volume 10c surrounded by the first recess 20. Preferably, a maximum diameter of the inner portion 28b is smaller than a minimum diameter of the outer portion 28a of the second recess 28. This facilitates the formation of the inner portion 28b of the second recess 28 also within the piston partial volume 10c of the primary piston 10 surrounded by the first recess 20.

In the embodiment of FIG. 1, at least the portion of the spindle 22 that is directed toward the primary piston 10 can be/is fastened in the second recess 28. For this purpose, the maximum diameter of the inner portion 28b of the second recess 28 can be (almost) equal to a maximum diameter of the portion of the spindle 22 fastened in the inner portion 28b. While the spindle 22 is fixed to the primary piston 10, the nut 24 can be excited to a rotational movement about the spindle 22 by means of an operation of the motor. Specifically, in the embodiment of FIG. 1, the nut 24 is supported by a bearing 30. By means of the rotational movement of the nut 24, the spindle 22 and the primary piston fastened thereto are adjusted linearly, the second recess 28/its outer portion 28a of the adjusted primary piston 10 receiving or releasing the portion of the rotating nut 24 that is directed toward the primary piston 10. Preferably, therefore, the minimum diameter of the outer portion 28a of the second recess 28 is larger than a maximum diameter of the portion of the nut 24 that can be inserted into the outer portion 28a.

As an advantageous development, in the embodiment of FIG. 1 at least one torque support component 32 is fastened or formed on the primary piston 10. By means of the at least one torque support component 32, the primary piston 10 can be supported on an inner wall of a transmission housing 34 of the transmission device 26 in such a way that an undesirable co-rotational movement of the primary piston 10 together with the nut 24 set in its rotational movement is prevented.

With respect to further features of the brake pressure generator of FIG. 1 and their advantages, reference is made to the following description.

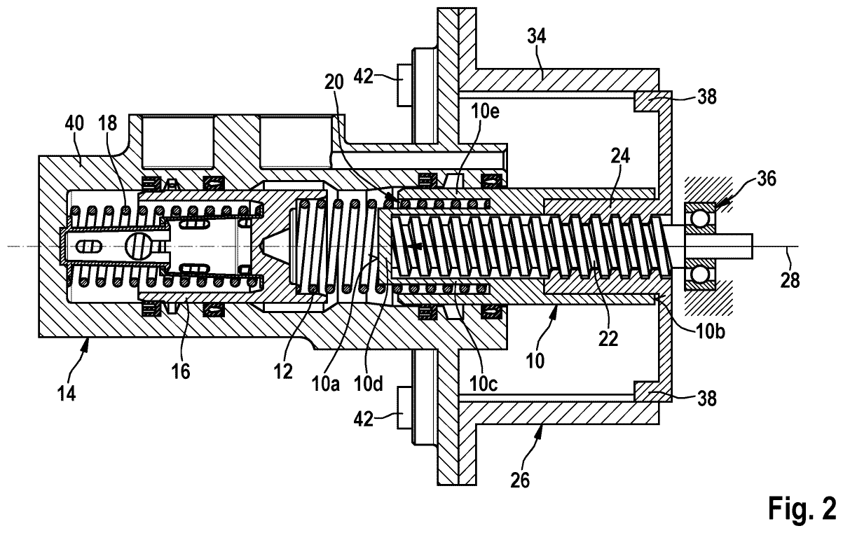

FIG. 2 is a schematic representation of a second embodiment of the primary piston, or the brake pressure generator equipped therewith.

In contrast to the above-described embodiment, in the primary piston 10 of FIG. 2 at least the portion of the nut 24 that is directed toward the primary piston 10 is/can be fastened in the second recess 28/its outer portion 28a. Preferably, for this purpose, a maximum diameter of the outer portion 28a of the second recess 28 is (substantially) equal to a maximum diameter of the portion of the nut 24 fastened in the second recess 28/its outer portion 28a. While the nut 24 is fixed to the primary piston 10, the spindle 22 can be excited to a rotational movement about a longitudinal axis of the spindle 22 in relation to the primary piston 10 by means of the operation of the motor. At least the portion of the spindle 22 set in rotation that is directed toward the primary piston 10 rotates into the second recess 28/its inner portion 28b or out of the second recess 28/its inner portion 28b during the rotational movement. Preferably, therefore, a minimum diameter of the inner portion 28b of the second recess 28 is larger than a maximum diameter of the portion of the spindle 22 that can be inserted into the inner portion 28b. To support the axial force, the spindle 22 can be supported by a bearing 36.

As can be seen from a comparison of FIGS. 1 and 2, in the embodiment of FIG. 1 the spindle 22 can penetrate into the second recess 28 up to the cover portion 10d. A maximum stroke of spindle 22 and nut 24 can therefore be completely accommodated in the installation space of the primary piston 10. Therefore, the brake pressure generator of FIG. 2 has a shorter overall length than the embodiment of FIG. 1. The compactness of the structure of the brake pressure generator shown in FIG. 2 is thus further optimized.

As an advantageous development, at least one torque support component 38 is fastened/formed on the nut 24 of the brake pressure generator of FIG. 2, by means of which the nut 24 and thus also the primary piston 10 are supported on the inner wall of the transmission housing 34 of the transmission device 26. An undesirable co-rotational movement of the primary piston 10 together with the spindle 22 set in its rotational movement is thus also prevented in the brake pressure generator of FIG. 2.

For further features and properties of the brake pressure generator of FIG. 2, reference is made to the description of the embodiment of FIG. 1 and the following explanations.

All brake pressure generators explained above can be used for a brake-by-wire braking system, a servo brake or a power brake. However, the usability of the brake pressure generators described above is not limited to the purposes listed here.

For each of the brake pressure generators described above, its nut 24 can also be referred to as a spindle nut. The nut 24 can be, for example, a ball nut or a threaded nut. The spindle 22 can be understood as a threaded spindle, a ball screw or a rack.

A housing 40 of the main brake cylinder 14 can be screwed to the transmission housing 34 of the transmission device 26 by means of at least one screw 42. This facilitates assembly of the main brake cylinder 14 on the transmission device 26 and enables quick and easy replacement of the main brake cylinder 14 in the event of servicing. Furthermore, in this case, the main brake cylinder 14 can be manufactured as a separate assembly, separately from the transmission device 26. Preferably, the housing 40 of the main brake cylinder 14 is a chill casting, such as in particular a chill casting made of aluminum. In this case, the main brake cylinder 14 can be manufactured relatively inexpensively.

All the brake pressure generators described above can be used to realize a dual-circuit braking system. However, it is pointed out that the main brake cylinder 14 of the brake pressure generators explained above is designed merely by way of example as a tandem main brake cylinder. Alternatively, the main brake cylinder 14 can also be designed for the hydraulic connection of only a single brake circuit.

It is pointed out again that all the brake pressure generators described above have a compact design and can be manufactured cost-effectively. Due to the advantageous use of the installation space of its primary piston 10, an undesirable protrusion of its spindle 22 into the passenger compartment of the vehicle equipped with it does not have to be accepted.

1-12. (canceled)

13. A primary piston for a main brake cylinder or a transmission device, the primary piston having, on a first side, a first recess into which at least one portion, directed toward the primary piston, of a primary spring of a main brake cylinder that is equipped with or cooperates with the primary piston, is able to be introduced or is fastened, the primary piston further having, on a second side, directed away from the first side, of the primary piston a second recess, into which at least one portion, directed toward the primary piston, of a spindle of a transmission device that is equipped with or cooperates with the primary piston and, at the same time, at least one portion, directed toward the primary piston, of a nut, arranged on the spindle, of the transmission device are able to be introduced and/or are fastened;
wherein the first recess, formed on the first side of the primary piston, frames at least one portion, directed toward the first side, of the second recess.

14. The primary piston according to claim 13, wherein at least the portion of the spindle that is directed toward the primary piston is or can be fastened in the second recess, while at the same time at least the portion of the nut set in a rotational movement about the spindle that is directed toward the primary piston can be introduced into the second recess.

15. The primary piston according to claim 13, wherein at least the portion of the nut that is directed toward the primary piston is or can be fastened in the second recess, while at the same time at least the portion of the spindle set in a rotational movement that is directed toward the primary piston can be introduced into the second recess.

16. The primary piston according to claim 15, wherein at least the portion of the nut that is directed toward the primary piston is fastened in the second recess, and the nut is a ball nut or a threaded nut.

17. A main brake cylinder for a brake-by-wire braking system, comprising:
a primary piston having, on a first side, a first recess into which at least one portion, directed toward the primary piston, of a primary spring of a main brake cylinder that is equipped with or cooperates with the primary piston, is able to be introduced or is fastened, the primary piston further having, on a second side, directed away from the first side, of the primary piston a second recess, into which at least one portion, directed toward the primary piston, of a spindle of a transmission device that is equipped with or cooperates with the primary piston and, at the same time, at least one portion, directed toward the primary piston, of a nut, arranged on the spindle, of the transmission device are able to be introduced and/or are fastened, wherein the first recess, formed on the first side of the primary piston, frames at least one portion, directed toward the first side, of the second recess; and
the primary spring interacting with the primary piston;
wherein at least the portion of the primary spring that is directed toward the primary piston is fastened in the first recess of the primary piston.

18. The main brake cylinder according to claim 17, wherein a housing of the main brake cylinder is a chill casting.

19. A transmission device for a brake-by-wire braking system, comprising:
a primary piston having, on a first side, a first recess into which at least one portion, directed toward the primary piston, of a primary spring of a main brake cylinder that is equipped with or cooperates with the primary piston, is able to be introduced or is fastened, the primary piston further having, on a second side, directed away from the first side, of the primary piston a second recess, into which at least one portion, directed toward the primary piston, of a spindle of a transmission device that is equipped with or cooperates with the primary piston and, at the same time, at least one portion, directed toward the primary piston, of a nut, arranged on the spindle, of the transmission device are able to be introduced and/or are fastened, wherein the first recess, formed on the first side of the primary piston, frames at least one portion, directed toward the first side, of the second recess; and
the spindle and the nut arranged on the spindle, which interact with the primary piston;
wherein at least the portion of the spindle that is directed toward the primary piston or at least the portion of the nut that is directed toward the primary piston is fastened in the second recess of the primary piston.

20. The transmission device according to claim 19, wherein at least the portion of the spindle that is directed toward the primary piston is fastened in the second recess of the primary piston, and wherein at least one torque support component is fastened or formed on the primary piston, using which the primary piston is supported on an inner wall of a transmission housing of the transmission device.

21. The transmission device according to claim 19, wherein at least the portion of the nut that is directed toward the primary piston is fastened in the second recess of the primary piston, and wherein at least one torque support component is fastened or formed on the nut, using which the nut is supported on the inner wall of a transmission housing of the transmission device.

22. A brake pressure generator for a brake-by-wire braking system, comprising:
a primary piston having, on a first side, a first recess into which at least one portion, directed toward the primary piston, of a primary spring of a main brake cylinder that is equipped with or cooperates with the primary piston, is able to be introduced or is fastened, the primary piston further having, on a second side, directed away from the first side, of the primary piston a second recess, into which at least one portion, directed toward the primary piston, of a spindle of a transmission device that is equipped with or cooperates with the primary piston and, at the same time, at least one portion, directed toward the primary piston, of a nut, arranged on the spindle, of the transmission device are able to be introduced and/or are fastened, wherein the first recess, formed on the first side of the primary piston, frames at least one portion, directed toward the first side, of the second recess;
the main brake cylinder cooperating with the primary piston and the primary spring, wherein at least the portion of the primary spring that is directed toward the primary piston is fastened in the first recess of the primary piston; and
the transmission device cooperating with the primary piston with the spindle and the nut arranged on the spindle, wherein at least the portion of the spindle that is directed toward the primary piston or at least the portion of the nut that is directed toward the primary piston is fastened in the second recess of the primary piston.

23. The brake pressure generator according to claim 22, wherein a housing of the main brake cylinder is a chill casting.

24. The brake pressure generator according to claim 22, wherein a housing of the main brake cylinder is screwed to a transmission housing of the transmission device.
